(19) United States
(12) Patent Application Publication
(10) Pub. No.: US 2020/0399897 A1
(43) Pub. Date: Dec. 24, 2020

(54) ENERGY-SAVING LIGHTING MASONRY MODULE

(71) Applicant: DALIAN UNIVERSITY OF TECHNOLOGY, Dalian, Liaoning (CN)

(72) Inventors: Ming SHAO, Dalian, Liaoning (CN); Hui YU, Dalian, Liaoning (CN); Yan CHEN, Dalian, Liaoning (CN); Dongsheng YAO, Dalian, Liaoning (CN); Jiaxuan LI, Dalian, Liaoning (CN); Adilijiang AYAN, Dalian, Liaoning (CN)

(21) Appl. No.: 16/962,028

(22) PCT Filed: Dec. 4, 2018
(86) PCT No.: PCT/CN2018/119023

§ 371 Date: Jul. 14, 2020

(30) Foreign Application Priority Data
Jan. 22, 2018 (CN) 201810077526.8

(51) Int. Cl. E04C 1/39; E04C 1/41; E04C 1/42; F21V 8/00; F21S 11/00; F21V 9/08

(52) U.S. Cl. CPC E04C 1/39; E04C 1/41; E04C 1/42; F21V 9/08; F21S 11/007; G02B 6/0008; G02B 6/0006

(57) ABSTRACT

An energy-saving lighting masonry module is disclosed. The module is mainly composed of a structural part, a thermal insulation part and a light transmitting part. A lens on an inlet end of a refraction region of the light transmitting part changes an optical path so that the light enters a total reflection light channel, and a lens on an outlet end restores the optical path to provide indoor illumination. The present invention uses the lenses and light guide to change the optical path to compress the light channel. The insulation material and optical devices in the energy-saving lighting masonry module are combined to form a block to achieve the combination mode of dual purposes of lighting and energy saving.

### TECHNICAL FIELD

The present invention belongs to the technical field of energy-saving lighting, and relates to an energy-saving lighting masonry module.

### BACKGROUND

As an important strategic measure for national sustainable development, building energy saving is also the main content of building a resource-saving society, and has become an important task for construction workers in the field of construction. In the building maintenance structure, doors and windows, exterior walls, roofs and ground are four parts of building energy consumption.

1. Energy-Saving Measures for Windows

Doors and windows are the weakest link of thermal insulation and energy saving in the envelope structure. Therefore, an existing technical solution is to determine a reasonable window-to-wall ratio and use an energy-saving window. In various energy-saving windows produced in China, the energy-saving effect of double glass plastic windows is more significant.

To design high-performance energy-saving windows, the most important thing is to select and match the most reasonable window manufacturing solution in various glass technologies, so as to meet the requirements of energy-saving for the windows. Double-layer and multi-layer hollow glass and tinted coated glass are frequently-used selection modes. The material, form and air tightness of window frames also have a certain influence on the energy-saving effect.

2. Application Status of Light-Transmitting Concrete Technology

By implanting glass fibers into the concrete, the fibers between both sides are placed in parallel in a matrix. The glass fibers do not have any negative influence on the strength of the concrete. The current successful case of using translucent concrete in China is Italy Pavilion at the 2010 Shanghai World Expo. Exterior walls of the translucent concrete are used to solve the lighting problem in some pavilions.

3. Application Status of Glass Brick

Glass brick is a transparent and hollow small block with glass as base material, and is often used for decoration of non-load-bearing external walls, internal partition walls, lighting roofs and building partitions. In view of the research status and engineering application of the glass brick in China, most glass bricks are used for decorative materials, and a few glass bricks are used for building exterior walls.

### Problems in the Prior Art

1. Problems in Energy-Saving Technology of Windows

(1) Multi-layer glass can improve the thermal insulation performance of the glass. Although the heat transfer loss of the multi-layer glass is significantly reduced, the reduction of visible light transmittance and solar heat gain coefficient is not satisfactory.

(2) The gas filled in the middle of an interlayer can improve the energy-saving performance of laminated glass windows. Krypton and argon are two frequently-used inert gases that are non-toxic, colorless, tasteless and chemically stable. After the krypton gas is filled, the thermal insulation performance of the glass is better than that of the argon, but the cost of the krypton gas is higher. The gas always has the problem of leakage. Thus, the technology is very dependent on the sealing quality of the glass.

(3) In most commercial buildings, Low-E coatings are generally used to reduce solar heat gain. Although this is beneficial for supplementing heating, the solar heat gain is reduced. Because the coatings have a strong influence on the outside world, the coatings reflect sunlight as strongly as a mirror and affect nearby buildings.

(4) PASSIVE120 aluminum-plastic composite new energy-saving window has a main body of wood, and thus is still a wooden window, and inherently has a certain thermal insulation capability. A multi-chamber engineering plastic profile as an accessory is provided with 0.65 three glass two cavity double Low-E double warm edge filled argon hollow glass, so that thermal insulation coefficient K value is 0.8 W/(M2·K) and the thermal insulation effect is particularly prominent. When the thermal insulation coefficient K value of the energy-saving window is gradually reduced, if the K value is less than 1.8 W/(M2·K), the K value is gradually reduced. The reduction speed of energy consumption is not so obvious, but the invested capital is increased exponentially, which means that the cost performance is low and the energy-saving window cannot be popularized and applied.

2. Problems in Light-Transmitting Concrete Technology

There are still some obstacles to the mass production of translucent concrete in China. At present, the technology for such translucent concrete in China is not yet mature. The high cost of the light rays has intangibly increased the production cost. Large-scale use is still unrealistic. Restricted by the technology and price, such translucent concrete is only used in a very small amount in China, and is only used for the decoration of interior finish. At present, Chinese scholars are still studying and experimenting various mechanics of translucent concrete blocks, and their performance is still under test. The application range is relatively narrow compared with foreign countries.

3. Problems in Glass Brick Technology

Although glass brick masonry walls can achieve the lighting effect, the thermal insulation effect is still inferior to that of concrete blocks, which is not conducive to thermal insulation and energy saving. Moreover, the glass brick masonry shall be supported by the load-bearing wall or frame structure.

The Prior Art Includes:

PASSIVE120 aluminum-plastic composite new energy-saving window, invention patent of Harbin Sayyas Window Industry Co., Ltd. in 2012.

Aerated concrete block insulation wall, utility model patent of Chengdu Sixth Construction Company in 2014.

Translucent concrete, theoretically proposed by the Hungarian architect Aron⋅ Losanzi in 2001 and successfully developed in 2003.

Glass brick, invention patent of St. Helens Pilkington Brothers PLC in 1929. The glass brick technology in China was introduced and produced by Dezhou Jinghua Group Zhenhua Decorative Glass Co., Ltd. in 2010.

### SUMMARY

The purpose of the present invention is to invent an energy-saving lighting masonry module to solve a contradiction between thermal insulation and energy saving and lighting of a wall, form a new building wall through masonry and obtain lighting, and thermal insulation and energy saving effects. The present invention has low cost and is suitable for application and popularization.

The technical solution of the present invention is:

An energy-saving lighting masonry module is mainly composed of a structural part 1, a thermal insulation part 2 and a light transmitting part 3.

The structural part 1 is a chamber structure, and has an H-shaped section to play a supporting role; the light transmitting part 3 is a symmetrical funnel structure and is located in the structural part 1; and the thermal insulation part 2 is thermal insulation material, and is filled in a gap between the structural part 1 and the light transmitting part 3.

The light transmitting part 3 is divided into refraction regions and a reflection region; the refraction regions are located on both ends of the light transmitting part 3; one end is an inlet end, and the other end is an outlet end; lenses are installed on the inlet end and the outlet end to play a role of refraction; the reflection region is a total reflection light channel for connecting two refraction regions; the lens on the inlet end of the refraction region changes an optical path so that the light enters the total reflection light channel, and the lens on the outlet end restores the optical path to provide indoor illumination.

The structural part 1 is made of concrete.

The thermal insulation part 2 is made of polyphenyl or rock wool.

The total reflection light channel is made of quartz optical fibers.

A concave lens is arranged at the outlet end of the refraction region, and can scatter light rays to create a comfortable indoor illumination environment.

A color filter is added to the total reflection light channel to filter harmful light rays in natural light.

All components in the energy-saving lighting masonry module are connected movably, and can be replaced if partially damaged or old.

The present invention has the following beneficial effects: the present invention uses the lenses and light guide to change the optical path to compress the light channel; The insulation material and optical devices in the energy-saving lighting masonry module are combined to form a block to achieve the combination mode of dual purposes of lighting and energy saving. The present invention is used for energy-saving renovation of existing buildings, and can meet the need of lighting through the renovation of local walls or window holes, so as to further reduce the windowing area of the buildings and increase the energy-saving efficiency of the buildings. The present invention can be used for window and wall renovation of roofs, wall surfaces, ground levels and old buildings. The present invention achieves the effects of lighting, thermal insulation and energy saving, has low cost, and is suitable for application and popularization.

### DESCRIPTION OF DRAWINGS

FIG. 1 is a schematic diagram of a lens focusing principle.

FIG. 2(a) is a schematic diagram a of a basic optical path diagram.

FIG. 2(b) is a schematic diagram b of a basic optical path diagram.

FIG. 3 is a schematic diagram of an internal structure of a masonry module.

FIG. 4 is a schematic diagram of a masonry module model.

FIG. 5 is a schematic diagram of an application model.

FIG. 6 is a schematic diagram of deformation of a masonry module.

FIG. 7 is a schematic diagram of a Fresnel lens module model.

FIG. 8 is a schematic diagram of deformation of a Fresnel lens module.

FIG. 9 is a schematic diagram of a module array 1.

FIG. 10 is a schematic diagram of a module array 2.

In the figures: 1 structural part; 2 thermal insulation part; 3 light transmitting part.

### DETAILED DESCRIPTION

Specific embodiments of the present invention are described below in detail in combination with the technical solution and accompanying drawings.

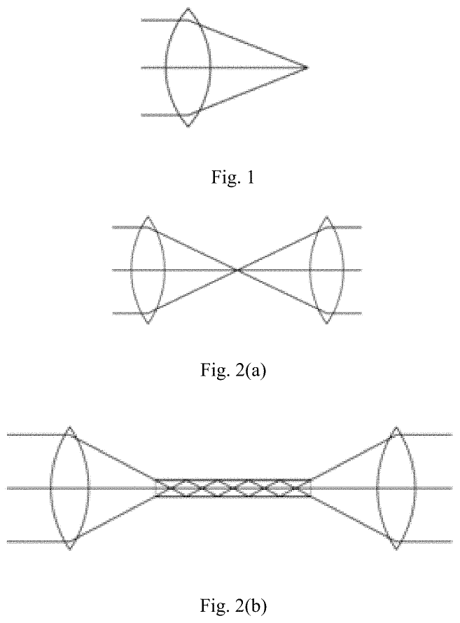

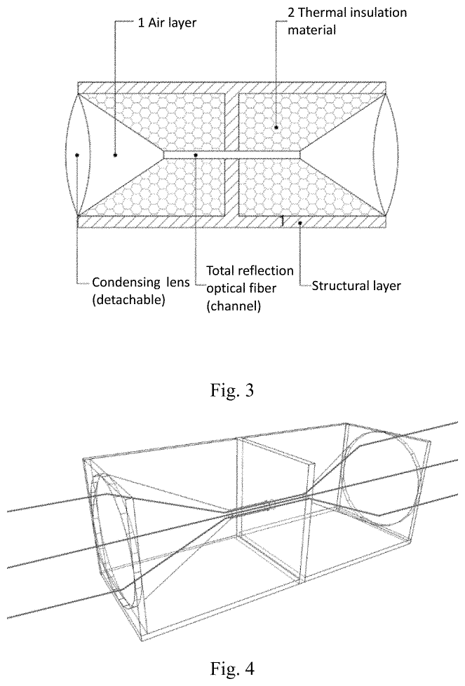

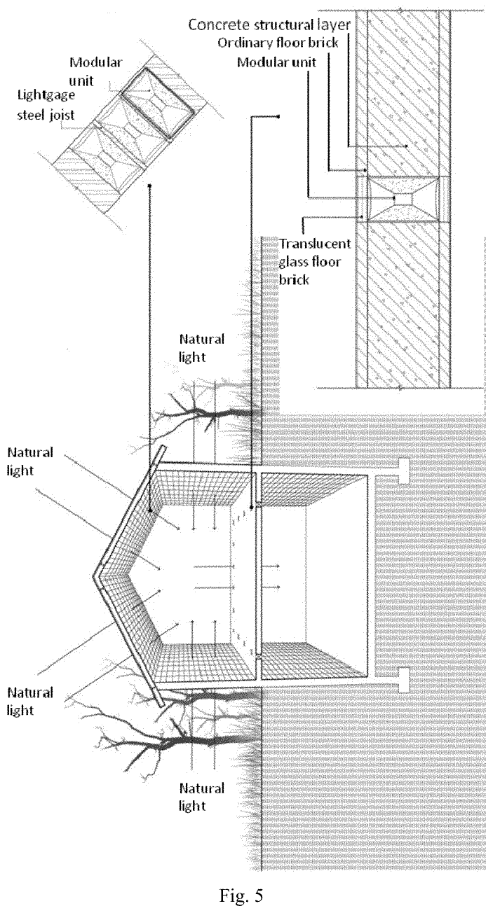

An energy-saving lighting masonry module uses lens refraction on an outer side (as shown in FIG. 1) to constrain natural light into quartz light guide through a vacuum layer and transmit the natural light to another end through the light guide; and then light rays are restored into the natural light through the vacuum layer and inner lens refraction so as to obtain natural lighting indoors, as shown in FIG. 2(a) and FIG. 2(b). The whole schematic diagrams of the energy-saving lighting masonry module are shown in FIG. 3 and FIG. 4; and the schematic diagram of practical application is shown in FIG. 5.

### Embodiment 1: Realization Mode of Modular Form

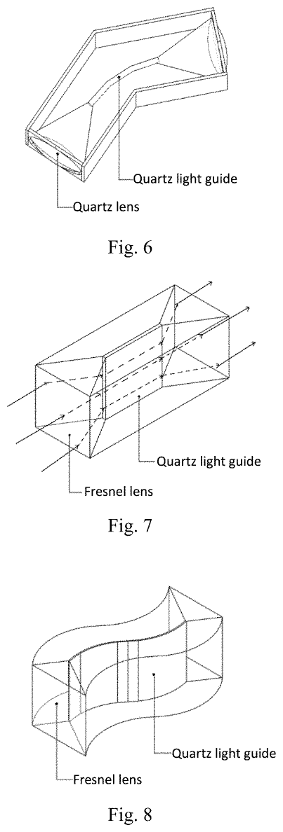

The light guide in the energy-saving lighting masonry module of the present invention can be freely expanded, contracted and deformed, and the modular form can be bent or twisted, as shown in FIG. 6.

The best angle can be adjusted in practical application to obtain adequate natural lighting.

### Embodiment 2: Realization Mode of Light Refraction at Outlet and Inlet

(1) A quartz convex lens used in the design of light outlet and inlet of the energy-saving lighting masonry module of the present invention can be replaced with a Fresnel lens, as shown in FIG. 7.

(2) A mirror surface of the Fresnel lens can be processed into a regular square or rectangle to expand the lighting area of the module. The internal light guide can also be processed into a curved surface, and the module can also be twisted and deformed accordingly, as shown in FIG. 8.

(3) The material of the lens can be replaced with composite materials such as resin and polymethyl methacrylate to improve wear resistance and beating resistance strength.

(4) A plurality of lenses form an array combination and share the same light guide channel.

### Embodiment 3: Realization Mode of Light Channel Total Reflection

A total reflection light guide channel in the energy-saving lighting masonry module of the present invention can be replaced with other materials or forms, such as inner wall total reflection coating pipelines, resin light pipe and liquid crystal light pipes.

### Embodiment 4: Realization Mode of Module Combination

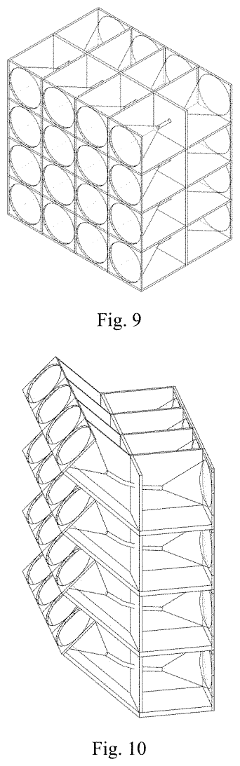

The energy-saving lighting masonry module of the present invention can be combined by a plurality of module arrays to form an aggregation module, so as to satisfy the needs of maximizing energy-saving lighting efficiency and realizing mass production, as shown in FIG. 9 and FIG. 10.

1. An energy-saving lighting masonry module, which is mainly composed of a structural part, a thermal insulation part and a light transmitting part,
wherein the structural part is a chamber structure, and has an H-shaped section to play a supporting role; the light transmitting part is a symmetrical funnel structure and is located in the structural part; and the thermal insulation part is thermal insulation material, and is filled in a gap between the structural part and the light transmitting part;
the light transmitting part is divided into refraction regions and a reflection region; the refraction regions are located on both ends of the light transmitting part; one end is an inlet end, and the other end is an outlet end; lenses are installed on the inlet end and the outlet end to play a role of refraction; the reflection region is a total reflection light channel for connecting two refraction regions; the lens on the inlet end of the refraction region changes an optical path so that the light enters the total reflection light channel, and the lens on the outlet end restores the optical path to provide indoor illumination.

2. The energy-saving lighting masonry module according to claim 1, wherein the structural part is made of concrete.

3. The energy-saving lighting masonry module according to claim 2, wherein the thermal insulation part, is made of polyphenyl or rock wool.

4. The energy-saving lighting masonry module according to claim 1, wherein the total reflection light channel is made of quartz optical fibers.

5. The energy-saving lighting masonry module according to claim 3, wherein the total reflection light channel is made of quartz optical fibers.

6. The energy-saving lighting masonry module according to claim 1, wherein a concave lens is arranged at the outlet end of the refraction region.

7. The energy-saving lighting masonry module according to claim 3, wherein a concave lens is arranged at the outlet end of the refraction region.

8. The energy-saving lighting masonry module according to claim 4, wherein a concave lens is arranged at the outlet end of the refraction region.

9. The energy-saving lighting masonry module according to claim 1, wherein a color filter is added to the total reflection light channel to filter harmful light rays in natural light.

10. The energy-saving lighting masonry module according to claim 6, wherein a color filter is added to the total reflection light channel to filter harmful light rays in natural light.
